(19) United States
(12) Patent Application Publication
(10) Pub. No.: US 2002/0118216 A1
(43) Pub. Date: Aug. 29, 2002

(54) Method of rendering a trimmed ribbon image and computer readable medium for storing a program containing the same

(76) Inventors: Tsung-Wei Lin, Taipei (TW); Chih-Hsuan Liu, Taipei (JP); Shih-Yang Wang, Taipei (JP)

Correspondence Address: BIRCH STEWART KOLASCH & BIRCH, PO BOX 747, FALLS CHURCH, VA, 22040-0747, US

(21) Appl. No.: 10/080,706

(22) Filed: Feb. 25, 2002

(30) Foreign Application Priority Data
Feb. 26, 2001 (JP) 90104351

(51) Int. Cl. G09G 5/00

(52) U.S. Cl. 345/619

(57) ABSTRACT

A method for rendering a trimmed ribbon image with a string. The user first inputs the string to be attached to the trimmed ribbon. Then a ribbon route of the trimmed ribbon is generated by a wrap function. Next, the ribbon route of the trimmed ribbon is cut into a plurality of sub-paths by several cutting points. The cutting points are determined by their slope values of tangent lines. The sub-paths and the attached string are applied by desired effect or shading functions to generate a plurality of segments of the trimmed ribbon, respectively. Finally, the segments are combined to produce the complete trimmed ribbon image.

### BACKGROUND OF THE INVENTION

1. Field of the Invention

The present invention relates to image processing technology, and particularly to a method of rendering a three-dimension (hereafter called 3D) trimmed ribbon image with a 3D shading, which is similar to that of a solid object, by utilizing wrap functions.

2. Description of the Prior Art

By virtue of the development of computer technology, most of the images or graphs, manually designed in the past, can be rendered by computers. In addition, the computer also helps professionals to add some special effects to designed images, generating visual effect that could not be obtained in the past. Accordingly, computer graphics technology has been applied in all kinds of fields. However, computer graphic technology is suitable for processing two-dimensional image objects and to produce two-dimension visual effects due to the limitation of the display devices and the features of the computers. The 3D visual effect is usually acquired by drawing the physical object from a perspective view.

For example, FIG. 1 (Prior Art) shows a 3D image of a trimmed ribbon object (i.e. a graphic object). In addition, FIG. 1 also illustrates an example of the 3D image of the trimmed ribbon object in the prior art. As shown in FIG. 1, the trimmed ribbon object 10 consists of a ribbon segment 100 near the observer and a ribbon segment 110 far from the observer. Usually, the observer can see an inner surface of the ribbon segment 100 and an outer surface of the ribbon segment 110 at the same time, and vice versa. Therefore, the 3D visual effect of the trimmed ribbon object can be achieved this way.

Apparently, the conventional rendering method of the trimmed ribbon object mentioned above is still based on planar graphic techniques. Therefore, it is quite difficult to add 3D effects, such as shading, to the two-dimension model of the trimmed ribbon object.

### SUMMARY OF THE INVENTION

Accordingly, the objective of the present invention is to provide a method for rendering a trimmed ribbon object, especially with a 3D effect such as shading.

The present invention achieves the above-indicated objects by providing a method for rendering a trimmed ribbon image with a string. The user first inputs the string to be attached to the trimmed ribbon. Then a ribbon route of the trimmed ribbon is generated by a wrap function. Next, the ribbon route of the trimmed ribbon is cut into a plurality of sub-paths by several cutting points. The cutting points are determined by their slope values of tangent lines. The sub-paths and the attached string are applied by desired effect or shading functions to generate a plurality of segments of the trimmed ribbon, respectively. Finally, the segments are combined to produce the complete trimmed ribbon image.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 (Prior Art) is a schematic diagram illustrating the image of a trimmed ribbon object in the conventional computer graphics;

FIG. 2 is a flowchart of a trimmed ribbon image with shading according to the preferred embodiment of the present invention;

FIG. 3 is a schematic diagram illustrating a string attached to the trimmed ribbon object according to the preferred embodiment of the present invention;

FIG. 4 is a schematic diagram illustrating an example of determining the locations of the sub-paths of the ribbon route in the preferred embodiment of the present invention;

FIG. 5 is a schematic diagram illustrating another example of determining the locations of the sub-paths of the ribbon route in the preferred embodiment of the present invention;

FIGS. 6A and 6B are schematic diagrams illustrating an additional cutting scheme when the cutting point or the cutting line cuts accros the interior of a letter of the string in the preferred embodiment of the present invention; and

FIG. 7 is a schematic diagram illustrating the trimmed ribbon image with shading according to the present embodiment of the present invention.

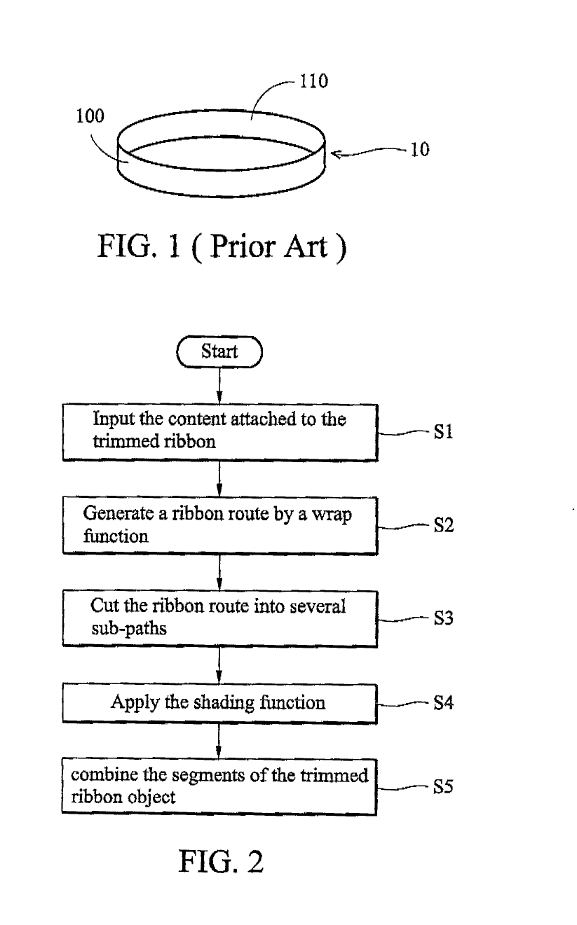

### DETAILED DESCRIPTION OF THE INVENTION

The rendering method provided in the present invention is to add a 3D visual effect, such as shading, to a trimmed ribbon object shown in a two-dimensional scheme. In the following description, shading is an example for illustrating the present invention.

FIG. 2 is a flowchart showing processing of a trimmed ribbon image with shading according to the preferred embodiment of the present invention. As shown in the figure, the user first inputs the content that is ready to be attached to a trimmed ribbon object (step S1). The content generally comprises a string with a plurality of letters.

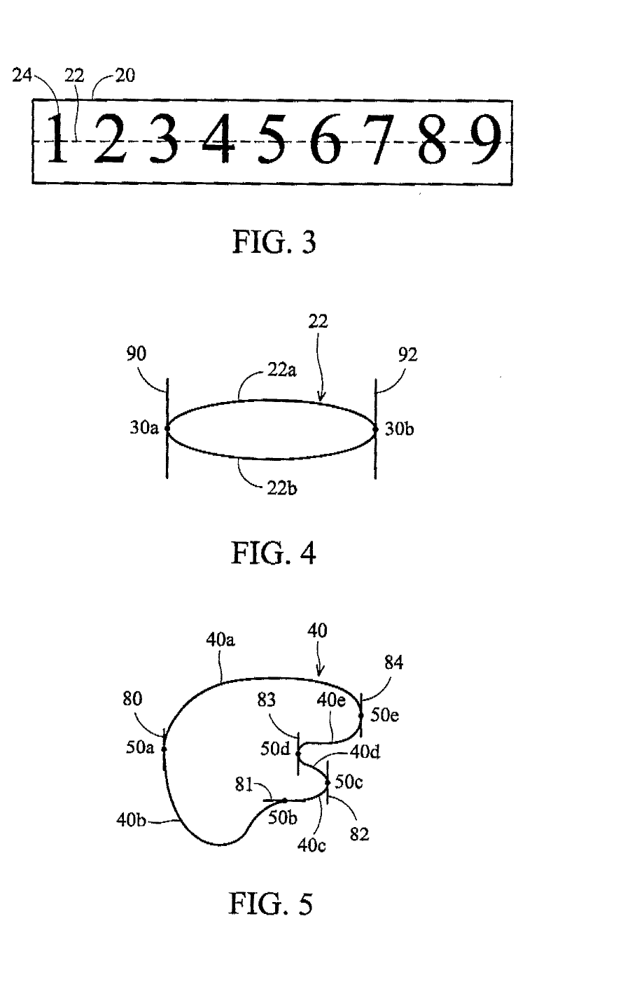

FIG. 3 is a schematic diagram illustrating an example of a string, ready to be attached to the trimmed ribbon object. As shown in the figure, the string 20 is composed of the nine letters 24, including “1, 2, 3, 4, 5, 6, 7, 8, 9,” wherein the symbol 22 represents the ribbon route.

Next, the contour of the ribbon route 22 is generated according to a wrap function specified by the user (step S2). The simplest contour is a pure ring, which is shown in FIG. 4. The pure ring can be generated by connecting the two ends of the ribbon route 22 in FIG. 3. In addition, the contour of the ribbon route 22 is determined by the shape of the trimmed ribbon object. For example, the contour of the ribbon route 22 also can be a circuitous ring shown in FIG. 5. No matter what the contour of the ribbon route 22 is, locations of the letters 24 on a newly-generated trimmed ribbon object can be determined since the locations of the letters 24 relative to the trimmed route 22 are known.

Next, the processed ribbon route 22 is cut into several sub-paths (step S3). In the preferred embodiment, the cutting points are chosen by the slopes of the points of the ribbon route 22. More specifically, in the preferred embodiment of the present invention, a point of the ribbon route 22 is a cutting point when the slope of the tangent at that point is a local maximum or a local minimum within its neighboring area. In addition, two different surfaces of the trimmed ribbon object corresponding to the ribbon route 22 are displayed in two sides of the cutting point. More specifically, the cutting point is determined when the first derivative of the function of the ribbon route 22 at that point is a local maximum or a local minimum and its second derivative is zero. FIG. 4 is a schematic diagram illustrating an example of determining the locations of the sub-paths of the ribbon route 22, wherein the trimmed route 22 is a pure ring. As shown in FIG. 4, a tangent line 90 is located at a cutting point 30a on the ribbon route 22 and a tangent line 92 is located at a cutting point 30b on the ribbon route 22. Therefore, the ribbon route 22 is divided into a sub-path 22a and a sub-path 22b. From the view of the observer, if one sub-path is shown in an outside surface, the other sub-path is shown in an inside surface.

In addition to the pure ring shown in FIG. 4, the ribbon route 22 may be other forms. FIG. 5 is a schematic diagram illustrating another example of determining the locations of the sub-paths of the ribbon route 40, wherein the ribbon route 40 is a circuitous ring. As shown in FIG. 5, the tangent lines 80, 81, 82, 83 and 84 are located at the cutting points 50a, 50b, 50c, 50d and 50e on the ribbon route 40. Therefore, the ribbon route 40 is divided into five sub-paths 40a, 40b, 40c, 40d and 40e.

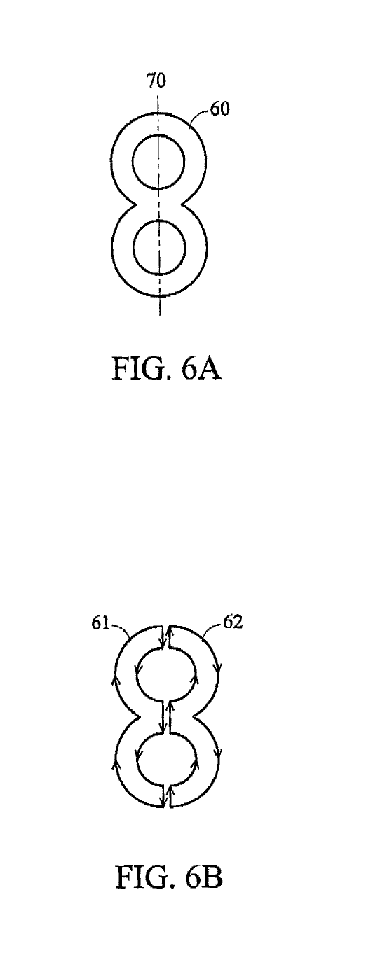

The determination of the cutting points (with a slope of the tangent lines to be a local minimum or a local maximum) in step S3 is based on the ribbon route. In addition, it is important that the ribbon route is used to locate the letters ready to be attached on the trimmed ribbon image. Therefore, an additional manipulation is required if a cutting point or a cutting line passing through the cutting point cuts across the interior of one of the letters. FIGS. 6A and 6B are schematic diagrams illustrating an additional cutting scheme when the cutting point or the cutting line cuts accros the interior of a letter of the string. In FIG. 6A, the letter 60 is “8” and the cutting line 70 passes through the interior of the letter 60. In FIG. 6B, the contour of the letter 60 is divided into two trajectories 61 and 62. The trajectory 61 is clockwise and the other trajectory 62 is counterclockwise. The two trajectories 61 and 62 are used to separate the graph of the letter “8” into two parts, which are assigned to two adjacent sub-paths, respectively.

Return to FIG. 2, after the sub-paths and the locations of the letters pertaining to the sub-paths are determined, several segments of the trimmed ribbon object with the attached letters are generated and further processed by shading (step S4). The shading functions are conventional and determined by various applications. The detailed description of the shading functions can be found in “Computer Graphics, principle and practice”, by James D. Foley.

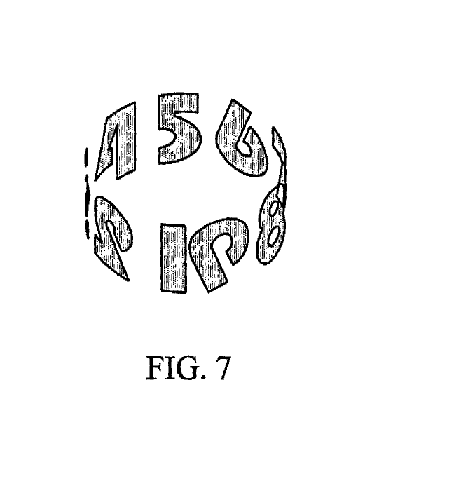

Finally, the segments with shading are combined to generate the complete trimmed ribbon image (step S5). FIG. 7 is a schematic diagram illustrating the trimmed ribbon image with shading according to the present embodiment of the present invention. As shown in FIG. 7, the letters are displayed in a clockwise order. Therefore, some of the characters are shown in the obverse side and others in the reverse.

The advantage of the present invention is to utilize 2D image processing techniques to add 3D shadings to a 3D trimmed ribbon image, which can provide better visual effects than the conventional methods.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for rendering a trimmed ribbon image on a display device of a computer, comprising the steps of:
inputting content ready to be displayed on a trimmed ribbon object;
generating a ribbon route for the trimmed ribbon object by a wrap function;
cutting the ribbon route of the trimmed ribbon object into a plurality of sub-paths by a plurality of cutting points on the ribbon route;
generating a plurality of segments by separatively applying an effect function to the sub-paths and the content attached to the sub-paths; and
combining the segments to produce the trimmed ribbon image.

2. The method of claim 1, wherein slope values of tangent lines passing through the cutting points are a local maximum value or a local minimum value.

3. The method of claim 1, wherein the content is a string with a plurality of letters.

4. The method of claim 3, wherein in the cutting step the letter is divided into two parts by generating two trajectories of a contour of the letter when the cutting points cutting across an interior of the letter.

5. The method of claim 1, wherein the effect function is shading.

6. A computer readable medium for storing a program, comprising the commands of:
inputting content that is ready to be displayed on a trimmed ribbon object;
generating a ribbon route of the trimmed ribbon object by a wrap function;
cutting the ribbon route of the trimmed ribbon object into a plurality of sub-paths by a plurality of cutting points on the ribbon route;
generating a plurality of segments by separatively applying an effect function to the sub-paths and the content attached to the sub-paths; and
combining the segments to produce the trimmed ribbon image.

7. The computer readable medium of claim 6, wherein slope values of tangent lines passing through the cutting points are a local maximum value or a local minimum value.

8. The computer readable medium of claim 6, wherein the content is a string with a plurality of letters.

9. The computer readable medium of claim 8, wherein in the cutting command the letter is divided into two parts by generating two trajectories of a contour of the letter when the cutting points cut across an interior of the letter.

10. The computer readable recorded medium of claim 6, wherein the effect function is shading.
